(19) United States
(12) Patent Application Publication
(10) Pub. No.: US 2011/0269041 A1
(43) Pub. Date: Nov. 3, 2011

(54) FUEL CELL COGENERATION SYSTEM

(75) Inventor: Satoshi Matsumoto, Hyogo (JP)

(73) Assignee: PANASONIC CORPORATION, Kadoma-shi, Osaka (JP)

(21) Appl. No.: 13/143,653

(22) PCT Filed: Nov. 1, 2010
(86) PCT No.: PCT/JP2010/006434

§ 371 Date: Jul. 7, 2011

(30) Foreign Application Priority Data
Nov. 2, 2009 (JP) 2009-251703

(51) Int. Cl. H01M 8/04

(52) U.S. Cl. 429/429

(57) ABSTRACT

A fuel cell cogeneration system according to the invention is disclosed, the system comprising: a fuel cell (1) for generating electric power through a reaction between a fuel gas and an oxidizing gas; a hot water storage tank (3) for storing hot water; a heat medium circulation path (8) in which a heat medium for exchanging heat with the fuel cell (1) circulates; a hot water circulation path (9) for causing heat exchange between the hot water flowing out of the hot water storage tank (3) and the heat medium and then sending the hot water back to the hot water storage tank (3); a hot water circulation pump (4) for circulating the hot water in the hot water circulation path (9); and a controller (19) that is configured to perform, during shut-down of the fuel cell cogeneration system, a forced hot water circulation operation in which the hot water circulation pump (4) is operated in an amount that is greater than a maximum operation amount of a power generation period of the fuel cell (1).

### TECHNICAL FIELD

The present invention relates to a fuel cell cogeneration system that produces hot water by recovering and making use of heat generated during power generation of a fuel cell.

### BACKGROUND ART

Fuel cells generate electric energy through a direct reaction between hydrogen and oxygen and are expected as clean power generation equipment that has high power generation efficiency and emits virtually no air pollutants. Especially, fuel cell cogeneration systems, which recover heat generated during power generation and utilize it for hot water supply, air heating or the like, have high total energy efficiency and are therefore expected to come into wide use as energy saving equipment.

One known fuel cell cogeneration system has such a configuration as shown in FIG. 8.

As shown in FIG. 8, the fuel cell cogeneration system includes a fuel cell 51, a hydrogen generator 52 and an air blower 67. The fuel cell 51 includes an anode 62 and a cathode 63. In the fuel cell 51, hydrogen generated by the hydrogen generator 52 is supplied to the anode 62 while oxygen in air is supplied from the air blower 67 to the cathode 63, and the hydrogen and oxygen thus supplied electrochemically react with each other, thereby generating electric power. The hydrogen generator 52 is configured to generate hydrogen by reforming a material gas such as methane by steam or the like.

The fuel cell 51 has a cooling water flow path 64 to which a cooling water circulation path 58 is connected. At positions in the cooling water circulation path 58, a cooling water heat exchanger 57 and a cooling water circulation pump 60 are provided. As the cooling water heat exchanger 57, a heat exchanger of the plate type or the shell-and-tube type is often used.

In addition, the fuel cell cogeneration system includes a hot water storage tank 53, a hot water circulation pump 54, an exhaust gas heat exchanger 55, a cathode off gas heat exchanger 56 and the cooling water heat exchanger 57. A hot water circulation path 59 connects the hot water storage tank 53, the hot water circulation pump 54, the exhaust gas heat exchanger 55, the cathode off gas heat exchanger 56 and the cooling water heat exchanger 57 in this order and is configured to heat hot water stored in the hot water storage tank 53

The hot water is city water generally supplied from a water supply pipe to the hot water storage tank 53 to be stored therein. The city water contains water hardness elements such as calcium and magnesium in addition to disinfectants such as chlorine. It contains large amounts of such water hardness elements in some districts.

These water hardness elements are featured in that the more the temperature of the water rises, the more they are likely to precipitate in the form of scales. Therefore, when the temperature of the hot water is high to some extent (e.g., when the temperature ranges from 75 degrees C. to 90 degrees C.), there is a possibility that the water hardness elements precipitate as scales on the surface of the pipe that constitutes the hot water circulation path 59, gradually clogging up the flow path (pipe). Especially, a portion of the hot water circulation path 59 which is located in the vicinity of the outlet of the cooling water heat exchanger 57 is the highest temperature part of the hot water circulation path 59 and therefore is the most susceptible to the formation of the scales.

For the purpose of suppressing the formation of the scales, a heat exchanger controller for a fuel cell has been proposed which controls the flow rate of a target fluid subjected to heat exchange such that the temperature of the target fluid subjected to heat exchange in the outlet of the heat exchanger becomes lower than or equal to a preset value (e.g., 60 degrees C.) (see e.g., Patent Literature 1).

There are also known a heat pump water heater that is intended to increase its durability against the scales and a water heater that is intended to remove the scales on a regular basis (see e.g., Patent Literatures 2 and 3). In the heat pump water heater disclosed in Patent Literature 2, the average flow rate of water flowing from a water flow path to a hot water supply end is made to be higher than or equal to a value that is about four times the average flow rate of water supplied from a water flow path to a hot water tank, whereby the precipitated scales are washed out. In the water heater disclosed in Patent Literature 3, upon an integrated value of operation time reaching a specified value, the circulator means for circulating a fluid subjected to heat exchange is operated at full blast, thereby removing the scales from a cooling-medium- to-water heat exchanger.
Patent Literature 1: Japanese Laid-Open Patent Application Publication No. 2004-296296
Patent Literature 2: Japanese Laid-Open Patent Application Publication No. 2006-125654
Patent Literature 3: Japanese Laid-Open Patent Application Publication No. 2005-308235

### SUMMARY OF THE INVENTION

### Technical Problem

The temperature controller for the heat exchanger of the fuel cell disclosed in Patent Literature 1, however, has revealed the following problem. In cases where heat necessary for hot water supply or air heating is to be obtained, that is, where a sufficient amount of hot water is to be stored in the hot water storage tank, the size of a hot water storage tank increases if the temperature of the hot water to be stored is low. More specifically, if the hot water stored in the hot water storage tank has a high temperature, a small amount of hot water stored in the hot water storage tank is sufficient, because it can be diluted with a large amount of tap water. Conversely, if the hot water stored in the hot water storage tank has a low temperature, a large amount of hot water has to be diluted with a small amount of tap water. Therefore, a large amount of hot water needs to be stored in the hot water storage tank.

Therefore, even in a case where the temperature of exhaust heat of the fuel cell is sufficiently high (e.g., about 80 to degrees C.), it becomes impossible to realize reduction of a size of a hot water storage tank and hence a size of an entire fuel cell cogeneration system, if the temperature of the stored hot water cannot be set to a high temperature because of a need to suppress the formation of the scales. Otherwise, it becomes impossible to realize a small-sized hot water storage tank and, in consequence, a small-sized fuel cell cogeneration system.

The scales may be removed by increasing the flow rate of the circulating hot water, like the water heaters disclosed in Patent Literatures 2 and 3. However, for example, if the circulating flow rate of the hot water is increased during power generation of the fuel cell, the temperature of the cooling water side of the cooling water heat exchanger 57 drops in the fuel cell cogeneration system shown in FIG. 8. As a result, the drop in the temperature of the fuel cell 51 causes steam condensation within the fuel cell 51 and, in consequence, flooding, which impedes the flows of the fuel gas and air. Furthermore, the amount of electric power generated by the fuel cell fluctuates, thereby resulting in reduced reliability of the fuel cell cogeneration system.

The present invention is directed to overcoming the foregoing problems and an object of the invention is therefore to provide a fuel cell cogeneration system capable of suppressing the precipitation of the water hardness elements and avoiding destabilization of the power generation of the fuel cell so that improved reliability can be ensured.

### Solution to Problem

The above object can be accomplished by a fuel cell cogeneration system according to the invention, the system comprising: a fuel cell for generating electric power through a reaction between a fuel gas and an oxidizing gas; a hot water storage tank for storing hot water; a heat medium circulation path in which a heat medium for exchanging heat with the fuel cell circulates; a hot water circulation path for causing heat exchange between the hot water flowing out of the hot water storage tank and the heat medium and then sending the hot water back to the hot water storage tank; a hot water circulation pump for circulating the hot water in the hot water circulation path; and a controller, wherein the controller is configured to perform, during shut-down of the fuel cell cogeneration system, a forced hot water circulation operation in which the hot water circulation pump is operated in an amount that is greater than a maximum operation amount of a power generation period of the fuel cell.

This makes it possible to suppress the clogging of the flow paths caused by scale generation and scale adhesion. In addition, if the temperature of the heat medium, which exchanges heat with the fuel cell, largely fluctuates with increases in the flow rate of the hot water, the fuel cell does not generate electric power because the fuel cell cogeneration system is in a shut down state. Therefore, the fuel cell cogeneration system of the invention can avoid destabilization of power generation in the fuel cell and therefore achieve an improvement in the reliability of the operation.

These objects as well as other objects, features and advantages of the invention will become apparent to those skilled in the art from the following description of preferred embodiments with reference to the accompanying drawings.

### Advantageous Effects of the Invention

According to the fuel cell cogeneration system of the invention, the precipitation of the scales can be suppressed and destabilization of power generation in the fuel cell can be avoided, so that the reliability of the operation can be improved.

### BRIEF DESCRIPTION OF THE DRAWINGS

FIG. 1 is a view showing a schematic configuration of a fuel cell cogeneration system according to a first embodiment of the invention.

FIG. 2 is a view showing a schematic configuration of a fuel cell cogeneration system according to a second embodiment of the invention.

FIG. 3 is a flow chart schematically showing a forced hot water circulation operation of the fuel cell cogeneration system according to the second embodiment.

FIG. 4 is a flow chart schematically showing a forced hot water circulation operation of the fuel cell cogeneration system according to the third embodiment.

FIG. 5 is a view showing a schematic configuration of a fuel cell cogeneration system according to a fourth embodiment of the invention.

FIG. 6 is a flow chart schematically showing a forced hot water circulation operation of the fuel cell cogeneration system according to the fourth embodiment.

FIG. 7 is a view showing a schematic configuration of a fuel cell cogeneration system according to a fifth embodiment of the invention.

FIG. 8 is a view showing a schematic configuration of a conventional fuel cell cogeneration system.

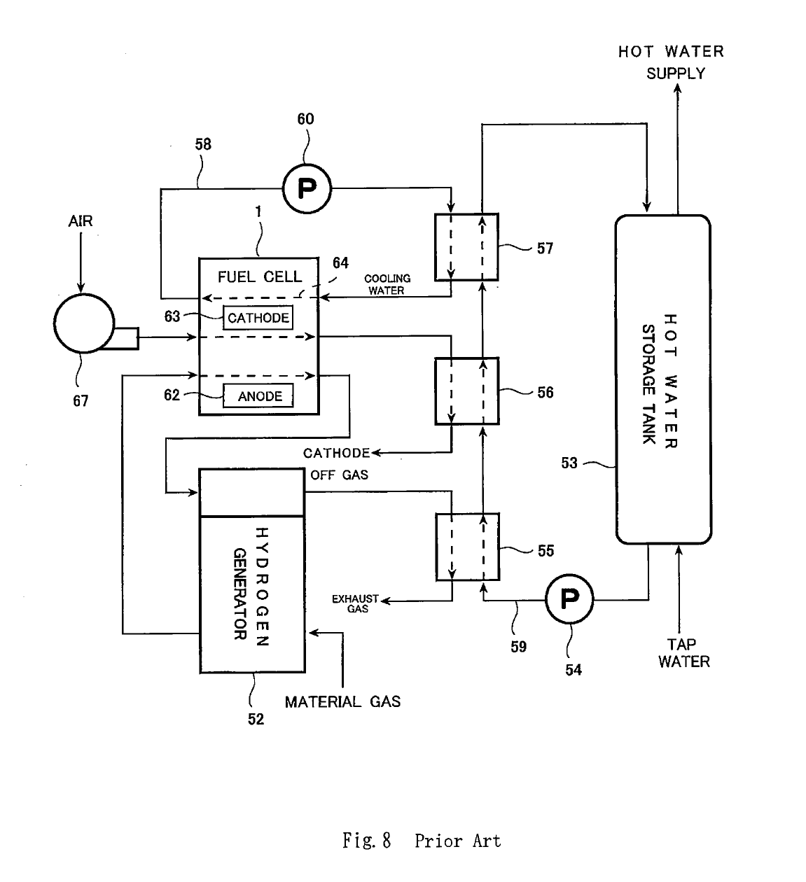

### DETAILED DESCRIPTION OF THE PREFERRED EMBODIMENTS

According to a first aspect of the invention, there is provided a fuel cell cogeneration system comprising: a fuel cell for generating electric power through a reaction between a fuel gas and an oxidizing gas; a hot water storage tank for storing hot water; a heat medium circulation path in which a heat medium for exchanging heat with the fuel cell circulates; a hot water circulation path for causing heat exchange between the hot water flowing out of the hot water storage tank and the heat medium and then sending the hot water back to the hot water storage tank; a hot water circulation pump for circulating the hot water in the hot water circulation path; and a controller, wherein the controller is configured to perform, during shut-down of the fuel cell cogeneration system, a forced hot water circulation operation in which the hot water circulation pump is operated in an amount that is greater than a maximum operation amount of a power generation period of the fuel cell.

The term “during shut-down of the fuel cell cogeneration system” stated herein is defined as the period after the controller starts the process of shutting down the fuel cell cogeneration system until the controller starts the process of the next operation of the fuel cell cogeneration system.

With the above configuration, the hot water flowing out of the hot water storage tank flows, in the hot water circulation path, with a flow rate higher than the maximum flow rate of the power generation period of the fuel cell. Therefore, the water hardness elements contained in the city water can be prevented from staying and being accumulated within the heat medium heat exchanger so that the clogging of the flow paths caused by scale generation and scale adhesion can be suppressed. Further, even if the temperature of the heat medium, which exchanges heat with the fuel cell, largely fluctuates with increases in the flow rate of the hot water, destabilization of power generation in the fuel cell can be avoided, so that the reliability of the operation can be improved, because the forced hot water circulation operation for scale removal is performed during the shut-down period of the fuel cell cogeneration system. It is therefore possible to provide a fuel cell cogeneration system having high reliability.

According to a second aspect, in the fuel cell cogeneration system of the first aspect, the controller may be configured to perform the forced hot water circulation operation when the hot water storage tank reaches a full state during shut-down of the fuel cell cogeneration system.

This makes it possible to perform the forced hot water circulation operation without breaking a temperature stratification formed in the hot water storage tank, the temperature stratification being the temperature layers of the hot water. As a result, it becomes possible to realize a much more convenient fuel cell cogeneration system.

According to a third aspect of the invention, in the fuel cell cogeneration system of the first aspect, the controller may be configured to perform the forced hot water circulation operation on a regular basis.

This makes it possible to suppress the scale generation even when the fuel cell cogeneration system is not operated for a prolong period because of, for example, a long absence of the user.

According to a fourth aspect, the fuel cell cogeneration system of the first or second aspect, may further comprise a heat medium heat exchanger for causing heat exchange between the heat medium in the heat medium circulation path and the hot water in the hot water circulation path and a hot water temperature detector for detecting the temperature of the hot water flowing out of the heat medium heat exchanger, and the controller may be configured to perform the forced hot water circulation operation until the temperature detected by the hot water temperature detector becomes lower than or equal to the first specified temperature, if the temperature detected by the hot water temperature detector exceeds a first specified temperature.

This makes it possible to suppress the scale generation dependent upon water temperature so that further improved reliability can be achieved.

According to a fifth aspect, in the fuel cell cogeneration system of the fourth aspect, the hot water circulation path may be configured to send the hot water which has exchanged heat with the heat medium back to an upper part of the hot water storage tank, and the system may further comprise a hot water circulation branch path that branches from the hot water circulation path at a downstream side of the heat medium heat exchanger to send the hot water flowing out of the heat medium heat exchanger back to a middle or lower part of the hot water storage tank and a flow path selector switch for switching a destination of the hot water flowing out of the heat medium heat exchanger to the hot water circulation branch path or the upper part of the hot water storage tank, and the controller may control the flow path selector switch so as to switch the destination of the hot water flowing out of the heat medium heat exchanger to the upper part of the hot water storage tank if the temperature detected by the hot water temperature detector exceeds a second specified temperature and switch the destination to the hot water circulation branch path if the temperature detected by the hot water temperature detector is lower than or equal to the second specified temperature.

This makes it possible to prevent low-temperature hot water from flowing into the high-temperature hot water stored in the upper part of the hot water storage tank so that the temperature of the hot water can be kept high without breaking the temperature stratification formed in the hot water storage tank. In consequence, the hot water storage tank and, therefore, the whole system can be made compact.

Referring now to the accompanying drawings, the embodiments of the invention will be hereinafter described. It is apparent that the invention is not limited to the particular embodiments shown herein. In all of these figures, the same or corresponding components are indicated by the same numerals and redundant explanations are omitted herein. In addition, in all of these figures, only the elements necessary for explaining the invention are selectively illustrated whereas illustration of other elements is skipped. Further, the invention is not limited to the following embodiments.

### First Embodiment

### Configuration of Fuel Cell Cogeneration System

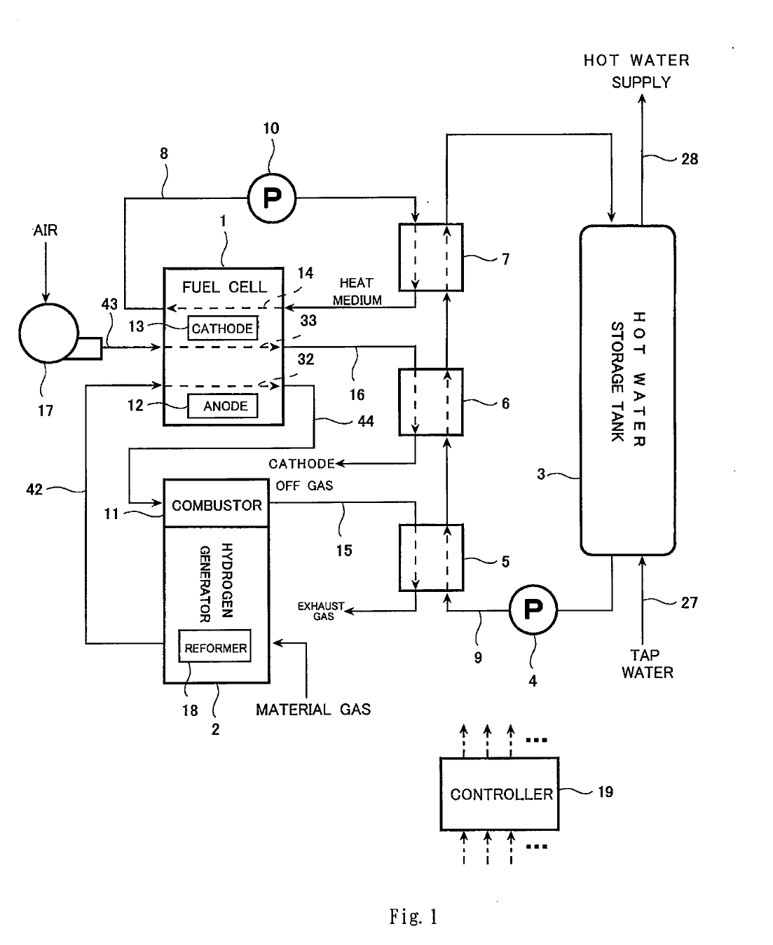

FIG. 1 is a view showing a schematic configuration of a fuel cell cogeneration system according to a first embodiment of the invention.

As illustrated in FIG. 1, the fuel cell cogeneration system 100 of the first embodiment is comprised of a fuel cell 1, a hot water storage tank 3, a heat medium circulation path 8, a hot water circulation path 9, a hot water circulation pump 4 and a controller 19. The controller 19 is configured to perform a forced hot water circulation operation during shut-down of the fuel cell cogeneration system 100 by operating the hot water circulation pump 4 with a higher flow rate than the maximum flow rate of the power generation period of the fuel cell 1.

The fuel cell cogeneration system 100 further includes a hydrogen generator 2 and an air blower 17. The hydrogen generator 2 has a combustor 11 and a reformer 18 and is configured to generate hydrogen from a material gas such as methane and propane through a reforming reaction (e.g., steam reforming reaction) by use of a catalyst. The hydrogen generator 2 is connected to an inlet of a fuel gas flow path 32 of the fuel cell 1 through a fuel gas supply path 42.

A downstream end of an anode off gas flow path 44 is connected to the combustor 11 as described later. Anode off gas is supplied from the fuel cell 1 to the combustor 11 as a combustion fuel after passing through an anode off gas flow path 44. Connected to the combustor 11 through an air supply path is a combustion fan (both are not shown). The combustion fan may be of any configuration as long as it can supply combustion air to the combustor 11. For example, it may be constituted by a fan, blower or the like.

In the combustor 11, the off fuel gas and combustion air which are supplied are combusted, thereby generating combustion exhaust gas (exhaust gas) and causing heat generation. The combustion exhaust gas generated in the combustor 11 heats the reformer 18 etc. and thereafter is discharged to a combustion exhaust gas flow path 15. While passing through the combustion exhaust gas flow path 15, the combustion exhaust gas discharged to the combustion exhaust gas flow path 15 exchanges heat with hot water flowing in the hot water circulation path 9 in the exhaust gas heat exchanger 5. The combustion exhaust gas, which has exchanged heat in the exhaust gas heat exchanger 5, is discharged outwardly from the fuel cell cogeneration system 100.

Connected to the reformer 18 are a material gas supplier and a steam supplier (both are not shown) which supply a material gas and steam, respectively, to the reformer 18. The reformer 18 has a reforming catalyst. As the reforming catalyst, any substances may be used as long as they serve as a catalyst in the steam reforming reaction between the material gas and steam to generate hydrogen-containing gas. Examples of the reforming catalyst include: ruthenium-based catalysts in which a catalyst carrier such as aluminum carries ruthenium (Ru) and nickel-based catalysts in which a similar catalyst carrier carries nickel (Ni).

The reformer 18 generates hydrogen-containing gas through a reforming reaction between the supplied material gas and steam. The hydrogen-containing gas generated is supplied to the fuel gas flow path 32 of the fuel cell 1 as the fuel gas after passing through the fuel gas supply path 42.

Although the first embodiment has been described with a configuration in which the hydrogen-containing gas generated in the reformer 18 is sent to the fuel cell 1 as the fuel gas, the invention is not limited to this but may be configured as follows. That is, the hydrogen-containing gas, which has passed through a shift converter or a carbon monoxide remover, may be sent to the fuel cell 1, the shift converter having a shift catalyst (e.g., copper-zinc-based catalyst) for reducing carbon monoxide contained in the hydrogen-containing gas sent from the reformer 18 of the hydrogen generator 2, and the carbon monoxide remover having an oxidization catalyst (e.g., ruthenium-based catalyst) or a methanation catalyst (e.g., ruthenium-based catalyst) for reducing carbon monoxide contained in the hydrogen-containing gas sent from the reformer 18 of the hydrogen generator 2.

The air blower 17 may be of any configuration as long as it can supply an oxidizing gas (air) to the fuel cell 1 while controlling the flow rate of the oxidizing gas. The air blower 17 may be constituted, for example, by a fan, blower or the like. Connected to the air blower 17 through an oxidizing gas supply path 43 is an inlet of an oxidizing gas flow path 33 of the fuel cell 1.

The fuel cell 1 has an anode 12 and a cathode 13. The fuel gas supplied to the fuel gas flow path 32 is supplied to the anode 12 while passing through the fuel gas flow path 32. The oxidizing gas supplied to the oxidizing gas flow path 33 is supplied to the cathode 13 while passing through the oxidizing gas flow path 33. The fuel gas supplied to the anode 12 and the oxidizing gas supplied to the cathode 13 react with each other, thereby generating electric power and heat.

The combustor 11 is connected to the outlet of the fuel gas flow path 32 of the fuel cell 1 through the anode off gas flow path 44. A cathode off gas flow path 16 is connected to the outlet of the oxidizing gas flow path 33, and a cathode off gas heat exchanger 6 is provided at a position in the cathode off gas flow path 16. Thereby, the fuel gas which has not been used in the fuel cell 1 is supplied to the combustor 11 as anode off gas. The oxidizing gas, which has not been used in the fuel cell 1, passes through the cathode off gas flow path 16 as cathode off gas and is then discharged outwardly from the fuel cell cogeneration system 100. In the cathode off gas heat exchanger 6, the cathode off gas heats the hot water flowing in the hot water circulation path 9 while passing through the cathode off gas flow path 16.

The fuel cell 1 is provided with a cooling flow path 14. Connected to the cooling flow path 14 is the heat medium circulation path 8. A heat medium circulation pump 10 and a heat medium heat exchanger 7 are provided at positions in the heat medium circulation path 8. The heat medium circulation pump 10 is configured such that a heat medium flows in the cooling flow path 14 and the heat medium circulation path 8. The heat medium circulation pump 10 is operated whereby the heat medium supplied to the cooling flow path 14 recovers heat generated in the fuel cell 1 (by exchanging heat with the fuel cell 1) and is then supplied to the heat medium circulation path 8. In the heat medium heat exchanger 7, the heat medium supplied to the heat medium circulation path 8 heats the hot water flowing in the hot water circulation path 9 while passing through the heat medium circulation path 8. As the heat medium, water (cooling water), an antifreezing solution (e.g., ethylene glycol solution) or the like may be used.

Note that the generated electric power is supplied to an external electric load (e.g., an electric household appliance) by a power conditioner (not shown). As the fuel cell 1, various types of fuel cells may be used examples of which include polymer electrolyte fuel cells, direct internal reforming solid oxide fuel cells, and indirect internal reforming solid oxide fuel cells. The configuration of the fuel cell 1 is similar to those of general fuel cells and therefore a detailed explanation thereof is omitted herein.

As the hot water storage tank 3, a so-called layered hot water tank is used herein which is so formed as to extend in a vertical direction. Connected to the hot water storage tank 3 is the hot water circulation path 9. More concretely, the upstream end of the hot water circulation path 9 is connected to the lower part of the hot water storage tank 3 while the downstream end thereof being connected to the upper part of the hot water storage tank 3.

The hot water circulation pump 4, which is a flow rate controllable pump, is provided at a position in the hot water circulation path 9. The exhaust gas heat exchanger 5, the cathode off gas heat exchanger 6 and the heat medium heat exchanger 7 are disposed in this order at positions in the hot water circulation path 9. As the heat medium heat exchanger 7, a heat exchanger of the plate type or the shell-and-tube type may be used. As the exhaust gas heat exchanger 5 and the cathode off gas heat exchanger 6, heat exchangers of the shell and tube type may be used taking account of pressure losses etc. on the gas side.

With this configuration, the low-temperature hot water existing in the lower part of the hot water storage tank 3 is heated by the exhaust gas heat exchanger 5, the cathode off gas heat exchanger 6 and the heat medium heat exchanger 7 while passing through the hot water circulation path 9 and is then supplied to the upper part of the hot water storage tank 3 as high-temperature hot water.

A hot water supply path 28 is connected to the upper part of the hot water storage tank 3, for supplying the hot water stored in the hot water storage tank 3 to an external heat load (such as a water heater). Connected to the lower part of the hot water storage tank 3 is a water supply path 27 for supplying city water. By opening a cock or valve (not shown) provided at the trailing end of the hot water supply path 28, the hot water stored in the hot water storage tank 3 is supplied to the external heat load (such as a water heater) under the supply pressure of the city water from the water supply path 27.

The controller 19 may be of any configuration as long as it can control the components of the fuel cell cogeneration system 100. The controller 19 has a calculation processing unit such as a microprocessor and CPU; a storage unit composed of memories etc. which store programs for executing respective control operations; and a timer. In the controller 19, the calculation operation unit reads a specified control program stored in the storage unit and executes the program thereby to process the information and perform this control and other various control operations on the fuel cell cogeneration system 100.

The controller 19 may be constituted by a single controller or a controller group consisting of plural controllers which cooperatively execute control on the fuel cell cogeneration system 100. The controller 19 may be constituted by a microcontroller or alternatively constituted by an MPU, PLC (programmable logic controller), logic circuit etc.

### (Operation of Fuel Cell Cogeneration System)

Next, the operation of the fuel cell cogeneration system 100 according to the first embodiment will be described with reference to FIG. 1. The power generation operation of the fuel cell cogeneration system 100 is similar to those of general fuel cell cogeneration systems and therefore an explanation thereof is omitted herein.

As stated earlier, the hot water stored in the hot water storage tank 3 is so-called city water supplied generally from a water supply pipe. The city water generally contains minute quantities of water hardness elements such as calcium and magnesium in addition to disinfectants such as chlorine and impurities such as iron and silica. The amount of the water hardness elements contained in city water varies depending on districts. In the city water of some districts, the water hardness elements are contained in concentrations exceeding, for example, 150 ppm.

These water hardness elements are featured in that the more the temperature of the water rises, the more they are likely to precipitate in the form of scales. Therefore, in cases where the temperature of the hot water is high to some extent (e.g., when the temperature ranges from 75 degrees C. to 90 degrees C.), there is a possibility that the water hardness elements precipitate as scales on the surface of the pipe that constitutes the hot water circulation path 9, gradually clogging up the flow path (pipe). For instance, the scales often precipitate when the temperature of the water is about 75 degrees C. or more, and the amount of the scales increases as the temperature rises. Therefore, there is a high risk that scale precipitation may occur in the vicinity of the outlet of the heat medium heat exchanger 7 of the hot water circulation path 9 because the temperature of this area is the highest in the hot water circulation path 9.

In addition, scale precipitation is likely to occur in areas where a water flow stagnates (that is, where no water flows or water flows at a very slow speed). In such stagnant areas, the water hardness elements are accumulated and concentrated gradually, which develops into scale creation and scale adhesion. In cases where a heat exchanger such as a plate-type heat exchanger is used as the heat medium heat exchanger 7 which heat exchanger is designed to create turbulent flows with the intent of promoting heat transfer by employing a complicated flow path configuration, hot water stagnation is likely to occur. Especially when the fuel cell cogeneration system 100 performs power generation operation with a low output, the amount of heat generated in the fuel cell 1 is small and therefore it is necessary to significantly reduce the flow rate of the hot water flowing in the hot water circulation path 9. Therefore, partial hot water stagnation is likely to occur within the heat medium heat exchanger 7.

However, the fuel cell cogeneration system 100 of the first embodiment is such that the controller 19 performs, during shut-down of the cogeneration system 100, the forced hot water circulation operation in which the hot water circulation pump 4 is operated in an amount greater than the maximum operating amount of the power generation period of the fuel cell 1.

The term “during shut-down of the fuel cell cogeneration system 100” stated herein is defined as the period after the controller 19 starts the process of shutting down the fuel cell cogeneration system 100 until the controller 19 starts the process of the next operation of the fuel cell cogeneration system 100.

This makes it possible to suppress the stagnation and accumulation of the water hardness elements in the hot water circulation path 9 and the heat exchangers such as the heat medium heat exchanger 7 and prevent the creation and adhesion of the scales. In addition, the forced hot water circulation operation is performed during shut-down of the fuel cell cogeneration system 100. Even if the temperature of the heat medium for exchanging heat with the fuel cell 1 largely fluctuates with increases in the flow rate of the hot water, power generation is not performed in the fuel cell 1 because the fuel cell cogeneration system 100 is in a shut down state. Because of this, the fuel cell cogeneration system 100 of the first embodiment can avoid the destabilization of power generation in the fuel cell 1 and ensures improved reliability for the operation.

In the fuel cell cogeneration system 100 of the first embodiment, the forced hot water circulation operation functions to not only suppress the stagnation of the water hardness elements and scale creation within the hot water circulation path 9 but also purge stagnant air from the hot water circulation path 9, the heat medium heat exchanger 7 and others. This makes it possible to suppress the destabilization of the hot water flow caused by the stagnation of air bubbles within the hot water circulation path 9, the heat medium heat exchanger 7 and others, the air bubbles being contained in the dissolved air generated when heating the hot water. This also enables it to suppress the deterioration in the heat exchange performance caused by a decrease in heat transfer area owing to air stagnation.

The controller 19 suitably performs the forced hot water circulation operation during a shut-down process for the fuel cell cogeneration system 100. The term “shut-down process for the fuel cell cogeneration system 100” stated herein is defined as the period after the controller 19 issues a shut-down command to the respective components of the fuel cell cogeneration system 100 until each process for shutting down the fuel cell cogeneration system 100 is completed, for instance, in a case where the user of the fuel cell cogeneration system 100 operates a remote controller (not shown) to stop the fuel cell cogeneration system 100 or where a predetermined shut-down time for the fuel cell cogeneration system 100 is up.

This causes an increase in the flow rate of the hot water, so that the amount of heat exchanged between the hot water and the heat medium in the heat medium heat exchanger 7 fluctuates. The fluctuation of the amount of exchanged heat causes a significant fluctuation in the temperature of the heat medium and, hence, a significant fluctuation in the temperature of the fuel cell 1. However, the destabilization of the power generation reaction in the fuel cell 1 can be avoided even if the temperature of the fuel cell 1 largely fluctuates, because the process for shutting down the fuel cell cogeneration system 100 is in progress. As a result, the fuel cell cogeneration system 100 of the first embodiment can ensure improved reliability for the operation.

The controller 19 may perform the forced hot water circulation operation after executing the process of shutting down the fuel cell cogeneration system 100. This makes it possible to suppress the water hardness elements from staying within the hot water circulation path 9 and others so that the reliability of the fuel cell cogeneration system 100 can be increased, especially when the fuel cell cogeneration system 100 is shut down over a long period of time.

In cases where the fuel cell cogeneration system 100 is not used over a prolonged period of time, the hot water is sometimes sterilized by heating the hot water within the hot water storage tank 3 and the hot water circulation path 9 by use of an external heat source (not shown) such as a gas combustor or electric heater. By performing the forced hot water circulation operation with the controller 19 during such heat sterilization, the precipitation of the scales caused by a rise in the temperature of the hot water can be prevented which leads to a further increase in the reliability of the fuel cell cogeneration system 100.

### Second Embodiment

According to a second embodiment, there is provided a fuel cell cogeneration system that is configured to perform the forced hot water circulation operation with the controller, when the hot water storage tank reaches a full state (level) during shut-down of the fuel cell cogeneration system.

### [Configuration of Fuel Cell Cogeneration System]

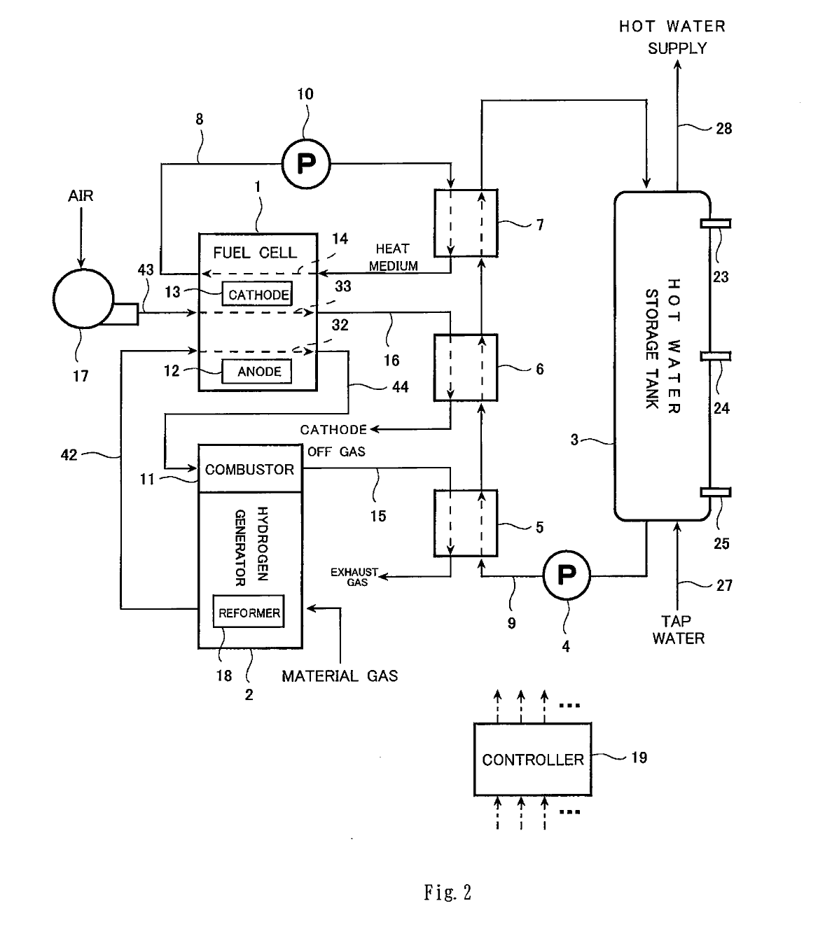

FIG. 2 is a view showing a schematic configuration of the fuel cell cogeneration system according to the second embodiment of the invention.

As shown in FIG. 2, the fuel cell cogeneration system 100 according to the second embodiment of the invention is the same as the fuel cell cogeneration system 100 of the first embodiment in basic configuration, but differs from the first embodiment in that the fuel cell cogeneration system 100 of the second embodiment is provided with a first temperature detector 23, a second temperature detector 24 and a third temperature detector 25. Specifically, the first temperature detector 23, the second temperature detector 24 and the third temperature detector 25 are provided in the upper part, middle part and lower part, respectively, of the hot water storage tank 3. The first temperature detector 23, the second temperature detector 24 and the third temperature detector 25 are respectively configured to detect the temperature of the hot water to output to the controller 19. As the first temperature detector 23 and others, thermistors, for example, may be used.

Although the temperature detectors are provided in the upper part, middle part and lower part of the hot water storage tank 3 in the second embodiment, the invention is not limited to this but may be applicable to cases where a desired number of temperature detectors are provided in desired locations of the hot water storage tank 3.

### [Operation of Fuel Cell Cogeneration System]

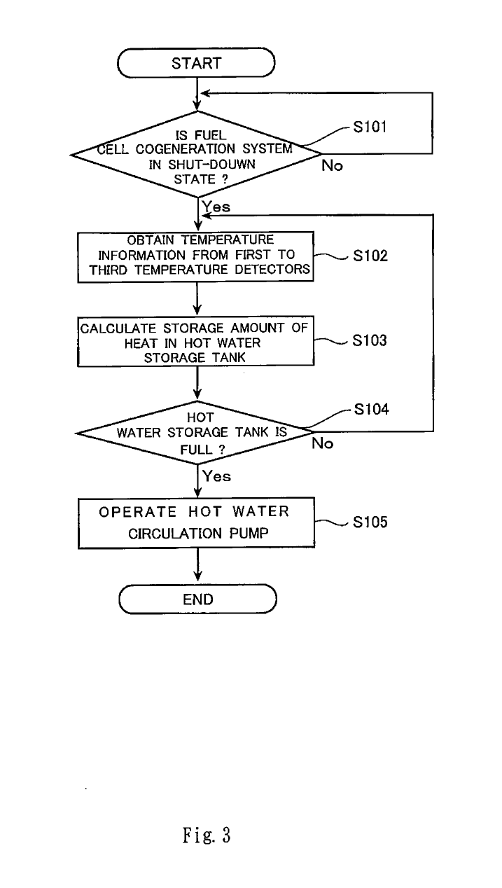

Reference is made to FIG. 3 to describe the operation of the fuel cell cogeneration system 100 according to the second embodiment.

FIG. 3 is a flow chart that schematically shows the forced hot water circulation operation of the fuel cell cogeneration system of the second embodiment.

As shown in FIG. 3, the controller 19 firstly determines whether or not the fuel cell cogeneration system 100 is in its shut-down state (Step S101). If it is determined that the fuel cell cogeneration system 100 is not in the shut-down state (“No” at Step S101), the controller 19 repeats Step S101 until the fuel cell cogeneration system 100 comes into the shut-down state. On the other hand, if it is determined that the fuel cell cogeneration system 100 is in the shut-down state (“Yes” at Step S101), the controller 19 proceeds to Step S102.

At Step S102, the controller 19 obtains temperature information on the hot water from the first to third temperature detectors 23 to 25. Then, the controller 19 calculates the amount of heat stored in the hot water storage tank 3 based on the temperature information obtained at Step S102 (Step S103). Thereafter, the controller 19 determines whether the hot water storage tank 3 is in the full state based on the amount of stored heat calculated at Step S103 (Step S104).

The term “the hot water storage tank 3 is in the full state” stated herein refers to a state where the hot water cannot absorb the heat generated in the fuel cell. More specifically, the full state refers to a state where, in the heat medium heat exchanger 7, the hot water flowing in the hot water circulation path 9 cannot receive heat from the heat medium which has recovered heat generated in the fuel cell 1. One example of such a state is a case where the temperature of the hot water detected by the third temperature detector 25 provided in the lower part of the hot water storage tank 3 becomes higher than or equal to a specified temperature, that is, a case where the temperature of the hot water flowing in the hot water circulation path 9 becomes higher than or equal to the specified temperature. The term “specified temperature” refers to such a high temperature that the heat generated in the fuel cell cannot be absorbed by the hot water. For example, the temperature of the lowest layer of the hot water storage tank 3 (the temperature detected by the third temperature detector 25) or the temperature of the hot water discharged from the lowest layer of the hot water storage tank 3 is in the range of from 40 degrees C. to 50 degrees C. It should be noted that, in this case, the average temperature of the hot water in the hot water storage tank 3 ranges from 60 degrees C. to 70 degrees C.

If it is determined that the hot water storage tank 3 is not in the full state (“No” at Step S104), the controller 19 returns to Step S102 to repeat Steps S102 to S104 until the hot water storage tank 3 reaches the full state. On the other hand, if it is determined that the hot water storage tank 3 is in the full state (“Yes” at Step S104), the controller 19 proceeds to Step S105. Although the controller 19 of this embodiment is configured to return to Step S102 if it is determined that the hot water storage tank 3 is not in the full state (“No” at Step S104), the controller 19 may be configured to return to Step S101 to repeat Steps S101 to S104.

At Step S105, the controller 19 operates the hot water circulation pump 4. More concretely, the controller 19 performs the forced hot water circulation operation with an operation amount greater than the maximum operation amount of the power generation period of the fuel cell 1.

Because of the above configuration, the fuel cell cogeneration system 100 of the second embodiment can achieve the same advantage as that of the fuel cell cogeneration system 100 of the first embodiment. In the fuel cell cogeneration system 100 of the second embodiment, since the forced hot water circulation operation is performed while the fuel cell cogeneration system 100 is in the shut-down state with the hot water storage tank being in the full state, the temperature stratification formed in the hot water storage tank 3, which stratification is the temperature layers of the hot water, is not broken. This further enhances the convenience of the fuel cell cogeneration system.

Although the third temperature detector 25 is provided in the lower part of the hot water storage tank 3 in the second embodiment, the invention is not limited to this. Instead, a temperature sensor may be provided, for instance, in the hot water supply path 28 connected to the hot water storage tank 3.

### Third Embodiment

In a fuel cell cogeneration system according to a third embodiment, the controller is configured to perform the forced hot water circulation operation on a regular basis.

### [Operation of Fuel Cell Cogeneration System]

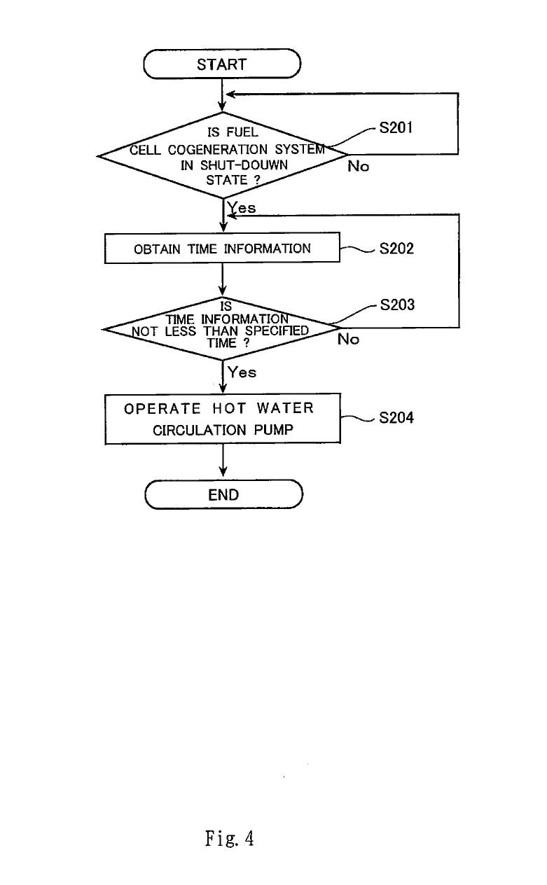

Reference is made to FIG. 4 to describe the operation of the fuel cell cogeneration system according to the third embodiment of the invention. The fuel cell cogeneration system 100 of the third embodiment has the same configuration as of the fuel cell cogeneration system 100 of the first embodiment and therefore an explanation thereof is omitted herein.

FIG. 4 is a flow chart that schematically shows the forced hot water circulation operation of the fuel cell cogeneration system of the third embodiment.

As shown in FIG. 4, the controller 19 firstly determines whether or not the fuel cell cogeneration system 100 is in the shut-down state (Step S201). If it is determined that the fuel cell cogeneration system 100 is not in the shut-down state (“No” at Step S201), the controller 19 repeats Step S201 until the fuel cell cogeneration system 100 comes into the shut-down state. On the other hand, if it is determined that the fuel cell cogeneration system 100 is in the shut-down state (“Yes” at Step S201), the controller 19 proceeds to Step S202.

At Step S202, the controller 19 obtains time information from the timer. Concretely, if the forced hot water circulation operation is not started after an instruction has been issued for starting the shut-down process for the fuel cell cogeneration system 100, the controller 19 obtains time information about the time elapsed since the issue of the instruction for starting the shut-down process. If the forced hot water circulation operation is performed after an instruction has been issued for starting the shut-down process for the fuel cell cogeneration system 100, the controller 19 obtains time information about the time elapsed since the last forced hot water circulation operation was performed.

Then, the controller 19 determines whether or not the time information obtained at Step S202 is not less than a specified time (Step S203). Note that the specified time can be arbitrarily set and may be set to, for example, such a value that the forced hot water circulation operation is performed once a day. If the time information obtained at Step S202 is determined to be less than the specified time (“No” at Step S203), the controller 19 returns to Step S202 to repeat Steps S202 and S203 until the time information becomes no less than the specified time. On the other hand, if the time information obtained at Step S202 is determined to be no less than the specified time (“Yes” at Step S203), the controller 19 proceeds to Step S204. Although the controller 19 returns to Step S202 if the time information obtained at Step S202 is determined to be less than the specified time (“No” at Step S203) in this embodiment, the invention is not limited to this but may be configured such that the controller 19 returns to Step S201.

At Step S204, the controller 19 performs the forced hot water circulation operation with a greater operation amount than the maximum operation amount of the power generation period of the fuel cell 1.

The fuel cell cogeneration system 100 of the third embodiment having the above configuration can achieve the same advantage as that of the fuel cell cogeneration system 100 of the first embodiment. The fuel cell cogeneration system 100 of the third embodiment can perform the forced hot water circulation operation on a regular basis so that the generation of the scales can be further suppressed.

Further, even if the fuel cell cogeneration system 100 is not used over a long period of time owing to, for example, absence of the user, the forced hot water circulation operation is regularly performed thereby suppressing the generation of the scales.

### Fourth Embodiment

According to a fourth embodiment of the invention, a fuel cell cogeneration system is provided which has the heat medium heat exchanger for causing heat exchange between the heat medium in the heat medium circulation path and the hot water in the hot water circulation path; and the hot water temperature detector for detecting the temperature of the hot water flowing out of the heat medium heat exchanger, wherein if the detected temperature of the hot water temperature detector exceeds a first specified temperature, the controller performs the forced hot water circulation operation until the detected temperature of the hot water temperature detector becomes lower than or equal to the first specified temperature.

### [Configuration of Fuel Cell Cogeneration System]

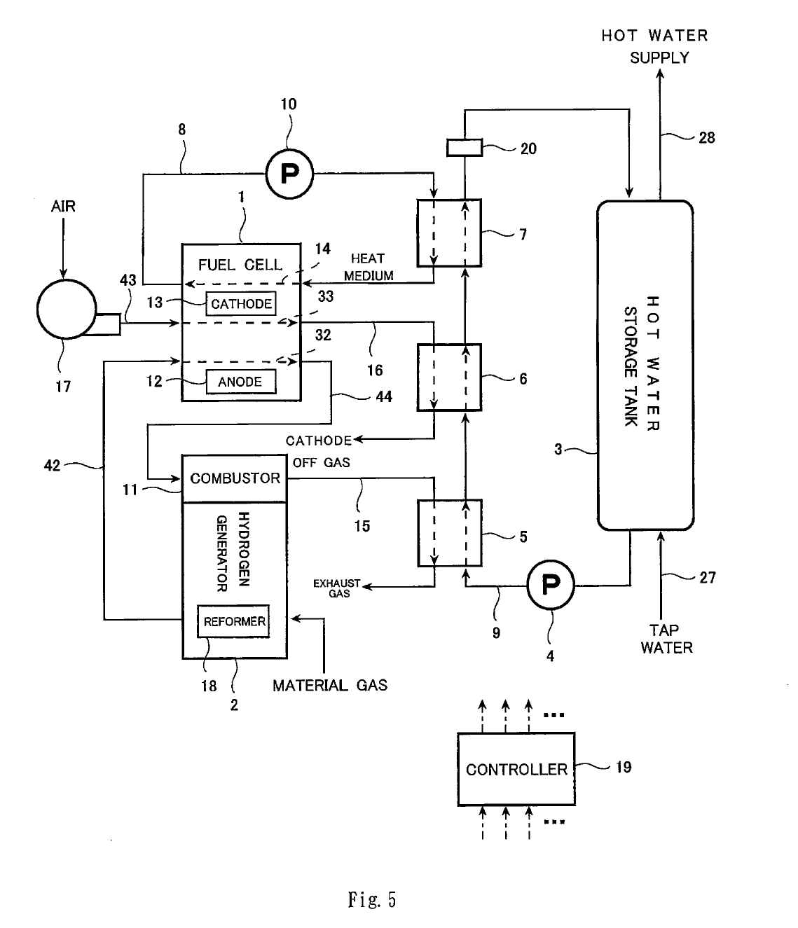

FIG. 5 is a view showing a schematic configuration of the fuel cell cogeneration system according to the fourth embodiment of the invention.

As shown in FIG. 5, the fuel cell cogeneration system 100 according to the fourth embodiment of the invention is the same as the fuel cell cogeneration system 100 of the first embodiment in basic configuration but differs from the first embodiment in that the fuel cell cogeneration system 100 of the fourth embodiment is provided with a hot water temperature detector 20.

Concretely, the hot water circulation path 9 is provided with the hot water temperature detector 20 that is located on the downstream side of a location where the heat medium heat exchanger 7 is disposed. The hot water temperature detector 20 is preferably disposed at a position close to the outlet of the heat medium heat exchanger 7 in the hot water circulation path 9 to accurately detect the temperature of the hot water flowing out of the heat medium heat exchanger 7. The hot water temperature detector 20 may be of any form as long as it can detect the temperature of the hot water and output the detected temperature to the controller 19. For example, a thermistor may be used.

The controller 19 controls the operation amount of the hot water circulation pump 4 and the flow rate of the hot water flowing in the hot water circulation path 9 such that the temperature of the hot water detected by the hot water temperature detector 20 becomes equal to a specified temperature.

### [Operation of Fuel Cell Cogeneration System]

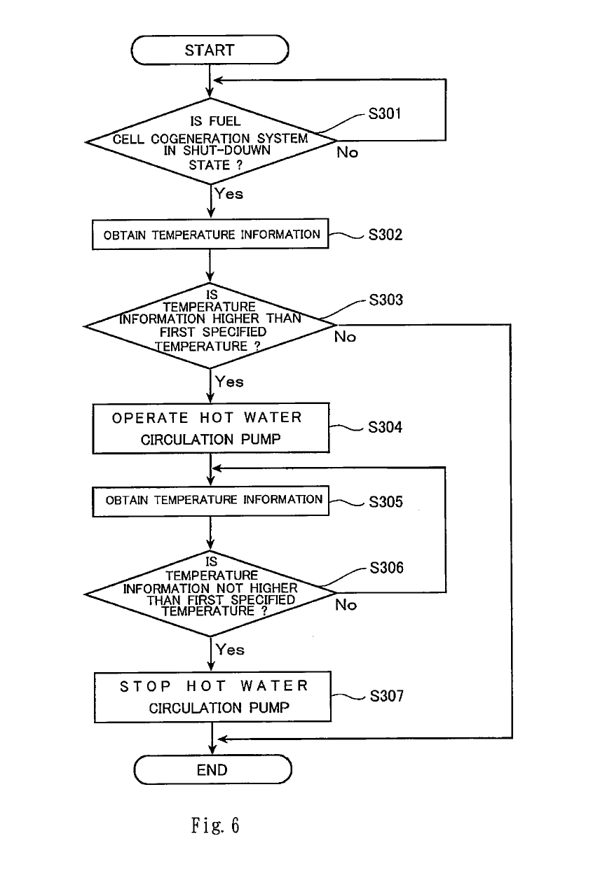

FIG. 6 is a flow chart schematically showing the forced hot water circulation operation of the fuel cell cogeneration system according to the fourth embodiment.

As shown in FIG. 6, the controller 19 firstly determines whether or not the fuel cell cogeneration system 100 is in the shut-down state (Step S301). If it is determined that the fuel cell cogeneration system 100 is not in the shut-down state (“No” at Step S301), the controller 19 repeats Step S301 until the fuel cell cogeneration system 100 comes into the shut-down state. On the other hand, if it is determined that the fuel cell cogeneration system 100 is in the shut-down state (“Yes” at Step S301), the controller 19 proceeds to Step S302.

At Step S302, the controller 19 obtains temperature information on the hot water from the hot water temperature detector 20. Then, the controller 19 determines whether the temperature information obtained at Step S302 is higher than the first specified temperature (Step S303). Note that the first specified temperature can be arbitrarily set and the temperature of the hot water flowing out of the heat medium heat exchanger 7 is preferably set to such a value that the scales are not generated. Preferably, the first specified temperature is slightly higher than the temperature of the city water supplied to the hot water storage tank 3. In this case, the water supply path 27 may be provided with a temperature detector for detecting the temperature of the city water flowing in the water supply path 27. Further, the first specified temperature may be set to, for example, 40 degrees C. to 60 degrees C. and more particularly set to 50 degrees C.

If the temperature information obtained at Step S302 is determined to be lower than or equal to the first specified temperature (“No” at Step S303), the controller 19 completes the process. On the other hand, if the temperature information obtained at Step S302 is determined to be higher than the first specified temperature (“Yes” at Step S303), the controller 19 proceeds to Step S304. Although the controller 19 returns to Step S302 if the temperature information obtained at Step S302 is determined to be lower than or equal to the first specified temperature (“No” at Step S303), the invention is not limited to this but may be configured such that the controller 19 returns to Step S301.

At Step S304, the controller 19 performs the forced hot water circulation operation with an operation amount greater than the maximum operation amount of the power generation period of the fuel cell 1. Then, the controller 19 obtains temperature information on the hot water from the hot water temperature detector 20 (Step S305).

Then, the controller 19 determines whether or not the temperature information obtained at Step S305 is lower than or equal to the first specified temperature (Step S306). If the temperature information obtained at Step S305 is determined to be higher than the first specified temperature (“No” at Step S306), the controller 19 returns to Step S305 to repeat Step S305 and Step S306 until the temperature information becomes lower than or equal to the first specified temperature.

On the other hand, if the temperature information obtained at Step S305 is determined to be lower than or equal to the first specified temperature (“Yes” at Step S306), the controller 19 proceeds to Step S307. At Step S307, the controller 19 stops the hot water circulation pump 4 thereby to stop the forced hot water circulation operation.

The fuel cell cogeneration system 100 of the fourth embodiment having the above configuration can achieve the same advantage as that of the fuel cell cogeneration system 100 of the first embodiment. In addition, the fuel cell cogeneration system 100 of the fourth embodiment can regulate the temperature of the hot water in the hot water circulation path 9, using the hot water temperature detector 20. Additionally, the generation of the scales dependent upon water temperature can be further suppressed by controlling the temperature of the hot water when performing the forced hot water circulation operation. As a result, the reliability of the fuel cell cogeneration system 100 can be further increased in the fuel cell cogeneration system 100 of the fourth embodiment.

### Fifth Embodiment

According to a fifth embodiment, there is provided a fuel cell cogeneration system including a hot water circulation branch path that branches from the hot water circulation path at a downstream side of the heat medium heat exchanger to send the hot water flowing out of the heat medium heat exchanger back to a middle or lower part of the hot water storage tank, and a flow path selector switch for switching the destination of the hot water flowing out of the heat medium heat exchanger to the hot water circulation branch path or an upper part of the hot water storage tank, and the hot water circulation path is configured to send the hot water which has exchanged heat with the heat medium back to the upper part of the hot water storage tank, and the controller controls the flow path selector switch so as to switch the destination of the hot water flowing out of the heat medium heat exchanger to the upper part of the hot water storage tank if the temperature detected by the hot water temperature detector exceeds a second specified temperature and switch the destination to the hot water circulation branch path if the temperature detected by the hot water temperature detector is lower than or equal to the second specified temperature.

### [Configuration of Fuel Cell Cogeneration System]

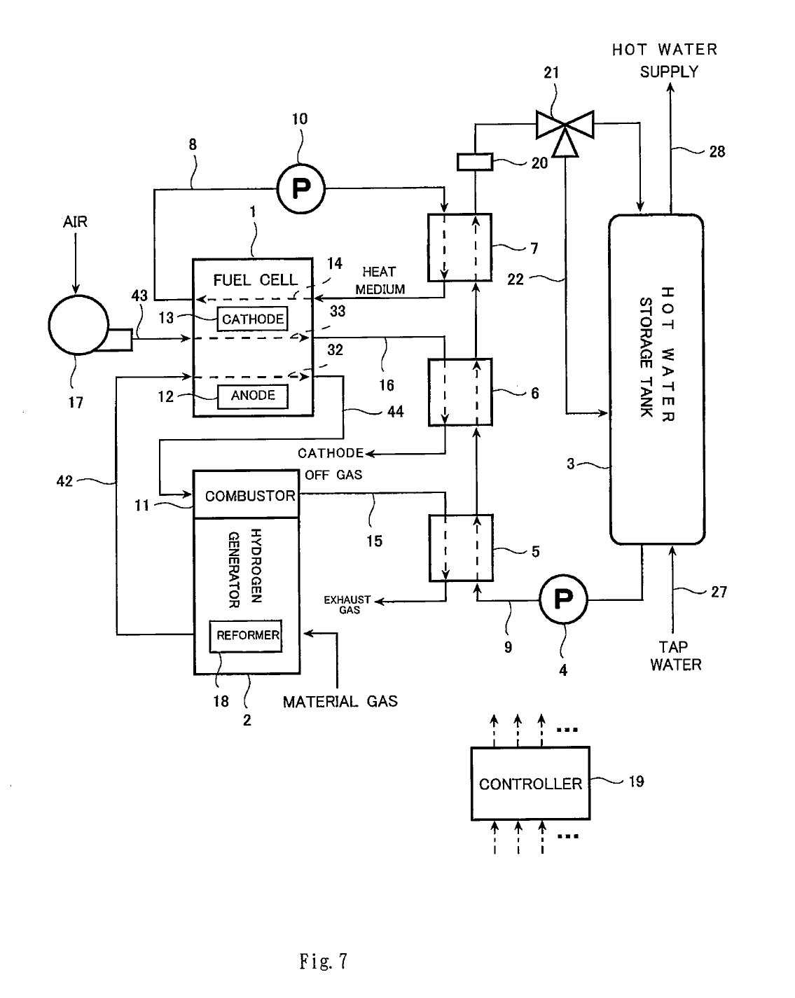

FIG. 7 is a view showing a schematic configuration of the fuel cell cogeneration system according to the fifth embodiment of the invention.

As shown in FIG. 7, the fuel cell cogeneration system 100 according to the fifth embodiment of the invention is the same as the fuel cell cogeneration system 100 of the fourth embodiment in basic configuration but differs from the fourth embodiment in that the fuel cell cogeneration system 100 of the fifth embodiment is provided with a flow path selector switch 21 and a hot water circulation branch path 22.

Concretely, the upstream end of the hot water circulation branch path 22 branches from the hot water circulation path 9 at a position on the downstream side of the heat medium heat exchanger 7, whereas its downstream end being connected to the middle part of the hot water storage tank 3. The flow path selector switch 21 is disposed at the position in the hot water circulation path 9 where the hot water circulation branch path 22 branches from the hot water circulation path 9 and is configured to switch the destination of the hot water flowing out from the heat medium heat exchanger 7 toward the hot water circulation path 9 to the hot water circulation branch path 22 or to the upper part of the hot water storage tank 3. The downstream end of the hot water circulation branch path 22 may be connected to the lower part of the hot water storage tank 3.

If the temperature of the hot water detected by the hot water temperature detector 20 exceeds the second specified temperature, the controller 19 controls the flow path selector switch 21 such that the destination of the hot water flowing out from the heat medium heat exchanger 7 to the hot water circulation path 9 is changed to the upper part of the hot water storage tank 3. Concretely, the controller 19 operates the flow path selector switch 21 such that an upstream part of the hot water circulation path 9 is communicated with a downstream part thereof, the upstream part being situated on the upstream side of the flow path selector switch 21 whereas the downstream part is situated on the downstream side of the same. Thereby, the discommunication between the hot water circulation path 9 and the hot water circulation branch path 22 is provided.

If the temperature of the hot water detected by the hot water temperature detector 20 is lower than or equal to the second specified temperature, the controller 19 controls the flow path selector switch 21 such that the destination of the hot water flowing from the heat medium heat exchanger 7 to the hot water circulation path 9 is changed to the hot water circulation branch path 22. Concretely, the controller 19 operates the flow path selector switch 21 such that the upstream part on the upstream side of the flow path selector switch 21 in the hot water circulation path 9 is communicated with the hot water circulation branch path 22, thereby providing discommunication between the upstream part on the upstream side of the flow path selector switch 21 in the hot water circulation path 9 and the downstream part on the downstream side of the flow path selector switch 21 in the hot water circulation path 9.

This suppresses the low-temperature hot water from flowing into the high-temperature hot water stored in the upper part of the hot water storage tank 3. As a result, in the fuel cell cogeneration system 100 of the fifth embodiment, the hot water can be kept at high temperature without breaking the temperature stratification formed within the hot water storage tank 3, so that the hot water storage tank 3 and, hence, the whole system can be made compact. Note that the second specified temperature can be arbitrarily set and is preferably in the range of 40 degrees C. to 60 degrees C. and more preferably 50 degrees C. in order to keep the temperature stratification formed within the hot water storage tank 3.

The controller 19 may be configured to perform the forced hot water circulation operation during a full shut-down process of the fuel cell cogeneration system 100. The term “full shut-down process of the fuel cell cogeneration system 100” stated herein refers to a process for shutting down the power generation operation of the fuel cell cogeneration system 100 upon the hot water storage tank 3 coming into a full state. When the hot water storage tank 3 is in the full state, the hot water in the hot water storage tank 3 has substantially uniform temperature higher than or equal to a specified temperature throughout from top to bottom. Therefore, the controller 19 may perform the forced hot water circulation operation without controlling the flow path selector switch 21 such that the destination of the hot water flowing from the heat medium heat exchanger 7 to the hot water circulation path 9 is set to the hot water circulation branch path 22. In this case, the controller 19 may perform the forced hot water circulation operation while controlling the flow path selector switch 21 such that the destination of the hot water flowing from the heat medium heat exchanger 7 to the hot water circulation path 9 is set to the hot water circulation branch path 22.

The fuel cell cogeneration system 100 of the fifth embodiment having the above configuration can achieve the same advantage as that of the fuel cell cogeneration system 100 of the fourth embodiment.

Although the exhaust gas heat exchanger 5 and the cathode off gas heat exchanger 6 are both provided in the configurations of the first to fifth embodiments, the invention is not limited to this but may be configured to have either one of these heat exchangers. The provision of such heat exchangers in the hot water circulation path 9 enables it to increase the amount of heat recovered by the hot water. This leads to an increase in the exhaust heat recovery efficiency of the fuel cell cogeneration system 100. In addition, since the provision of these heat exchangers in the hot water circulation path 9 enables it to increase the flow rate of the hot water during normal power generation operation, the water hardness elements can be suppressed from staying in the hot water circulation path 9 and the heat exchangers such as the heat medium heat exchanger 7 so that the generation of the scales can be further suppressed.

Numerous modifications and alternative embodiments of the invention will be apparent to those skilled in the art in view of the foregoing description. Accordingly, the description is to be construed as illustrative only, and is provided for the purpose of teaching those skilled in the art the best mode of carrying out the invention. The details of the structure and/or function may be varied substantially without departing from the spirit of the invention. Further, various inventions can be formed by suitable combinations of plural component elements disclosed in the above-described embodiments.

### INDUSTRIAL APPLICABILITY

Since the fuel cell cogeneration system of the invention enables it to suppress clogging of the flow paths caused by scale generation and scale adhesion and avoid destabilization of the power generation of the fuel cell, it finds advantageous utilization in the field of fuel cells.

### REFERENCE SIGNS LISTS

1: fuel cell
2: hydrogen generator
3: hot water storage tank
4: hot water circulation pump
5: exhaust gas heat exchanger
6: cathode off gas heat exchanger
7: heat medium heat exchanger
8: heat medium circulation path
9: hot water circulation path
10: heat medium circulation pump
11: combustor
12: anode
13: cathode
14: cooling flow path
15: exhaust gas flow path
16: cathode off gas flow path
17: air blower
18: reformer
19: controller
20: hot water temperature detector
21: flow path selector switch
22: hot water circulation branch path
23: first temperature detector
24: second temperature detector
25: third temperature detector
26: water level detector
27: water supply path
28: hot water supply path
32: fuel gas flow path
33: oxidizing gas flow path
42: fuel gas supply path
43: oxidizing gas supply path
44: anode off gas flow path
51: fuel cell
52: hydrogen generator
53: hot water storage tank
54: hot water circulation pump
55: exhaust gas heat exchanger
56: cathode off gas heat exchanger
57: cooling water heat exchanger
58: cooling water circulation path
59: hot water circulation path
60: cooling water circulation pump
62: anode
63: cathode
64: cooling water flow path
67: air blower
100: fuel cell cogeneration system

1. A fuel cell cogeneration system including a fuel cell for generating electric power through a reaction between a fuel gas and an oxidizing gas, the system comprising:
a hot water storage tank for storing hot water;
a heat medium circulation path in which a heat medium for exchanging heat with the fuel cell circulates;
a hot water circulation path for causing heat exchange between the hot water flowing out of the hot water storage tank and the heat medium and then sending the hot water back to the hot water storage tank;
a hot water circulation pump for circulating the hot water in the hot water circulation path; and
a controller,
wherein the controller is configured to perform, during shut-down of the fuel cell cogeneration system, a forced hot water circulation operation in which the hot water circulation pump is operated in an amount that is greater than a maximum operation amount of a power generation period of the fuel cell.

2. The fuel cell cogeneration system according to claim 1, wherein the controller is configured to perform the forced hot water circulation operation when the hot water storage tank reaches a full state during shut-down of the fuel cell cogeneration system.

3. The fuel cell cogeneration system according to claim 1, wherein the controller is configured to perform the forced hot water circulation operation on a regular basis.

4. The fuel cell cogeneration system according to claim 1, further comprising:
a heat medium heat exchanger for causing heat exchange between the heat medium in the heat medium circulation path and the hot water in the hot water circulation path; and
a hot water temperature detector for detecting the temperature of the hot water flowing out of the heat medium heat exchanger,
wherein the controller is configured to perform the forced hot water circulation operation until the temperature detected by the hot water temperature detector becomes lower than or equal to the first specified temperature, if the temperature detected by the hot water temperature detector exceeds a first specified temperature.

5. The fuel cell cogeneration system according to claim 4, wherein the hot water circulation path is configured to send the hot water which has exchanged heat with the heat medium back to an upper part of the hot water storage tank,
the fuel cell cogeneration system comprising:
a hot water circulation branch path that branches from the hot water circulation path at a downstream side of the heat medium heat exchanger to send the hot water flowing out of the heat medium heat exchanger back to a middle or lower part of the hot water storage tank; and
a flow path selector switch for switching a destination of the hot water flowing out of the heat medium heat exchanger to the hot water circulation branch path or the upper part of the hot water storage tank; and
wherein the controller controls the flow path selector switch so as to switch the destination of the hot water flowing out of the heat medium heat exchanger to the upper part of the hot water storage tank if the temperature detected by the hot water temperature detector exceeds a second specified temperature and switch the destination to the hot water circulation branch path if the temperature detected by the hot water temperature detector is lower than or equal to the second specified temperature.
